(19) United States
(12) Patent Application Publication
(10) Pub. No.: US 2025/0077798 A1
(43) Pub. Date: Mar. 6, 2025

(54) LARGE LANGUAGE MODEL (LLM)-ENHANCED VIRTUAL ASSISTANTS

(71) Applicant: Zoom Video Communications, Inc., San Jose, CA (US)

(72) Inventors: Andrew Kent Carluccio, San Francisco, CA (US); Wei Dai, Hangzhou (CN); Bilung Lee, Irvine, CA (US); Vijay Venkataswamy Parthasarathy, San Jose, CA (US); Haoming Zhong, Hangzhou (CN)

(73) Assignee: Zoom Video Communications, Inc., San Jose, CA (US)

(21) Appl. No.: 18/822,899

(22) Filed: Sep. 3, 2024

Related U.S. Application Data
(63) Continuation-in-part of application No. PCT/CN2023/116810, filed on Sep. 4, 2023.

(51) Int. Cl. G06F 40/40; G06F 9/451

(52) U.S. Cl. CPC G06F 40/40; G06F 9/453

(57) ABSTRACT

One example method includes receiving, by a virtual assistant, a task from a remote client device; transmitting a first prompt to a large language model (“LLM”), the first prompt comprising the task and a request to process the task; receiving, from the LLM in response to the first prompt, a plurality of sub-tasks and an ordering of the plurality of sub-tasks; obtaining descriptions of a plurality of available services; for each sub-task: transmitting a second prompt to the LLM, the second prompt comprising a description of the respective sub-task and the descriptions of the available services; receiving, from the LLM in response to the respective second prompt, an identification of one or more available services; and initiating, for the respective sub-task, the one or more identified available services; and after completion of the plurality of sub-tasks, generating and providing a response to the task to the remote client device.

### CROSS-REFERENCE

This application is a continuation-in-part of PCT Application No. PCT/CN2023/116810, titled “Large Language Model (LLM)-Enhanced Virtual Assistants,” filed Sep. 4, 2023, the entirety of which is incorporated herein by reference.

### FIELD

The present application generally relates to virtual assistants, and more particularly relates to large language model (“LLM”)-enhanced virtual assistants.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for LLM-enhanced virtual assistants;

FIGS. 3A-3B show an example system for LLM-enhanced virtual assistants;

FIGS. 3C-3E shows example graphical user interfaces for LLM-enhanced virtual assistants;

FIG. 4 shows an example graphical user interface for LLM-enhanced virtual assistants;

FIG. 5 shows an example method for LLM-enhanced virtual assistants; and

FIG. 6 shows an example computing device suitable for use with example systems and methods for LLM-enhanced virtual assistants according to this disclosure.

### DETAILED DESCRIPTION

Examples are described herein in the context of LLM-enhanced virtual assistants. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

During a typical day, a user may need to perform any number of tasks; however, for some tasks, they may lack the time or the expertise to quickly address them. Thus, the user may seek assistance with those tasks from an artificial intelligence (“AI”)-based virtual assistant. An AI virtual assistant may be programmed to receive a text input from the user, interpret that input to identify one or more actions to perform, and a result to provide to the user. To enable the AI virtual assistant to effectively understand and handle a request from the user, an AI virtual assistant may be designed to include a task coordinator function that coordinates actions of a query processor, a large language model (“LLM”), one or more identified tasks, available functionality to address particular tasks, and interfaces to those functionalities. It may also track the completion status of various tasks and, when complete, respond to the user about the result.

In one example, a user may type a task into a prompt area of a graphical user interface (“GUI”) for the AI virtual assistant to handle. The task is then received by a query transformation module, which communicates with a LLM to identify one or more subtasks that must be performed to accomplish task. The LLM responds with the sub-tasks required by the original task, the order in which the sub-tasks must be performed, and whether any additional information is needed from the user. Once the sub-tasks have been identified and ordered, the coordinator obtains information about available service functionalities that can be employed to obtain data, perform processing, or generate output as needed by the sub-tasks. The information includes a written description about the capabilities of each of the service functionalities.

For each sub-task, the LLM is provided the sub-task and the descriptions of the available service functionalities to determine which service functionality (or functionalities) should be employed to perform the sub-task. The LLM then responds with the identified service functionality as well as any other information needed to perform the sub-task. The coordinator then allows the sub-task to interface with the identified service functionality, such as through an application programming interface (“API”) or a messaging interface.

The service functionalities may be any suitable functionality that may be needed. For example, service functionalities may provide data storage, such as a database or cloud storage, to obtain information needed for the task, or it may include scheduling functionality to setup a meeting, or it may include email functionality to start a new email. Thus, when a service functionality is identified for a sub-task as providing the needed functionality, the sub-task can interact with the service functionality to provide the necessary information to the service functionality to allow it to perform its operations.

The coordinator ensures that the different sub-tasks operate in the correct sequence. As each sub-task completes, the coordinator updates its own records on the remaining sub-tasks and initiates the next sub-task or sub-tasks to be performed. Once all of the sub-tasks have completed, the coordinator initiates a response generator to create an output for the user based on their task. The response depends on the nature of the original task requested. Some tasks may request information or the answer to a question. In such a case, the response generator obtains information from the sub-tasks and employs the LLM to generate a response using the obtained information. Some other tasks involve taking one or more actions, such as scheduling a meeting or drafting an email. Thus, the response generation may provide a draft meeting invitation or email message. Still other kinds of tasks may involve other actions or responses. The response generator, after generating the response, provides it to the user and the task is completed.

Such an AI virtual assistant may provide enhanced capabilities of responding to user tasks or questions because it is able to analyze a received task to identify sub-tasks that may be performed, in sequence or in parallel, to obtain information or execute actions, needed as a part of handling the task or query. Thus, the system is able to systematically deconstruct the task into individual components that can be handled by service functionalities available to the user, and ultimately generate the output(s) or action(s) required by the user's original input. This may enable the user to provide more complicated tasks and be assured that they will be addressed correctly.

Zoom's goal is to invest in AI-driven innovation that enhances user experience and productivity while prioritizing trust, safety, and privacy. In August, Zoom shared that it does not use any customer audio, video, chat, screen-sharing, attachments, or other communications-like customer content (such as poll results, whiteboards, or reactions) to train Zoom's or third-party artificial intelligence models. Additionally, AI Companion is turned off by default—account owners and administrators control whether to enable these AI features for their accounts. Zoom provides admins and users control and visibility when AI features are being used or activated. By putting its customers' privacy needs first, Zoom is taking a leadership position, enabling its customers to use AI Companion and its capabilities with confidence.

This illustrative example is given to introduce the reader to the general subject matter discussed herein and the disclosure is not limited to this example. The following sections describe various additional non-limiting examples and examples of LLM-enhanced virtual assistants.

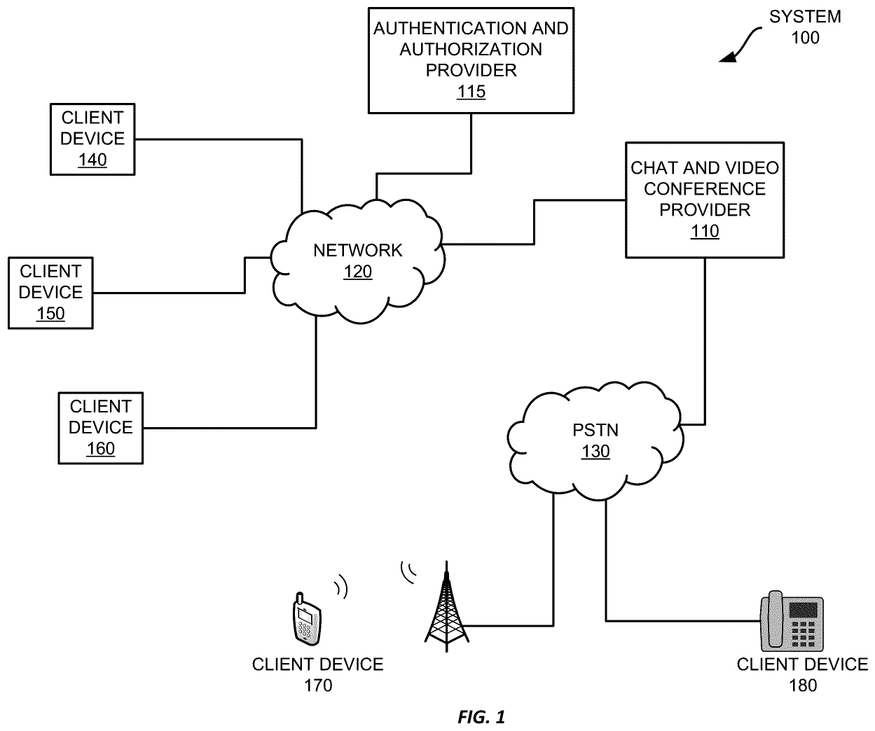

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

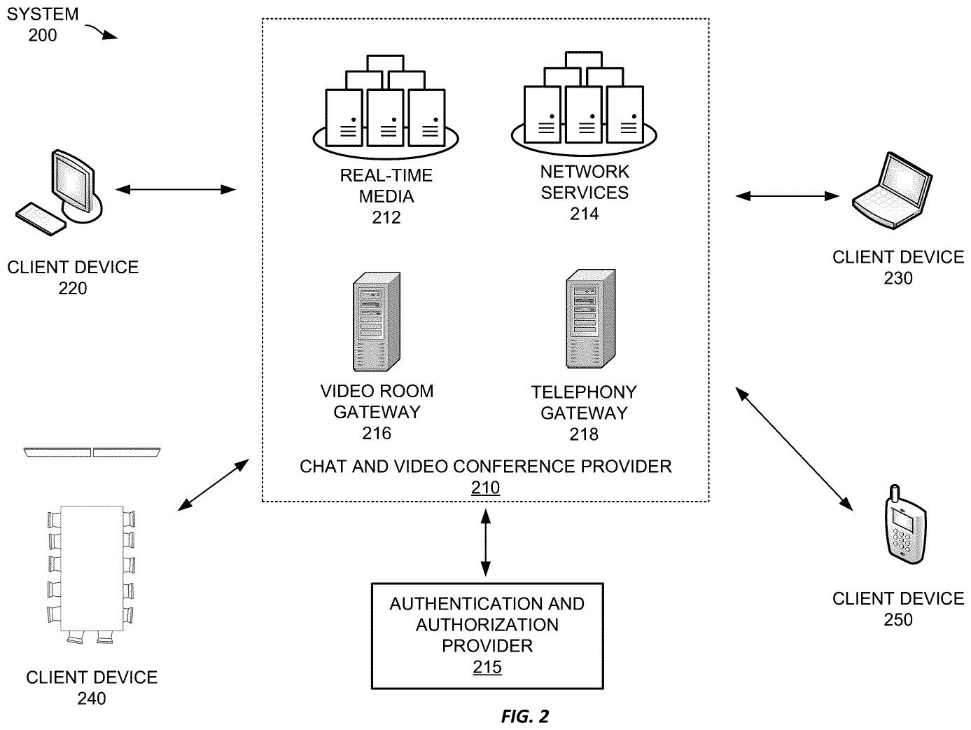

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

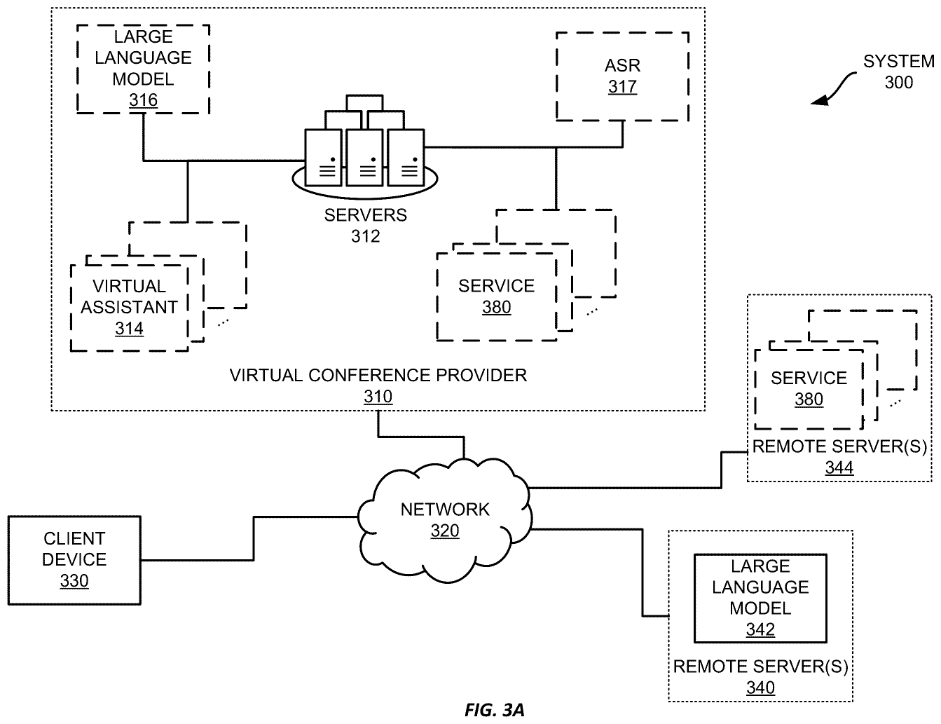

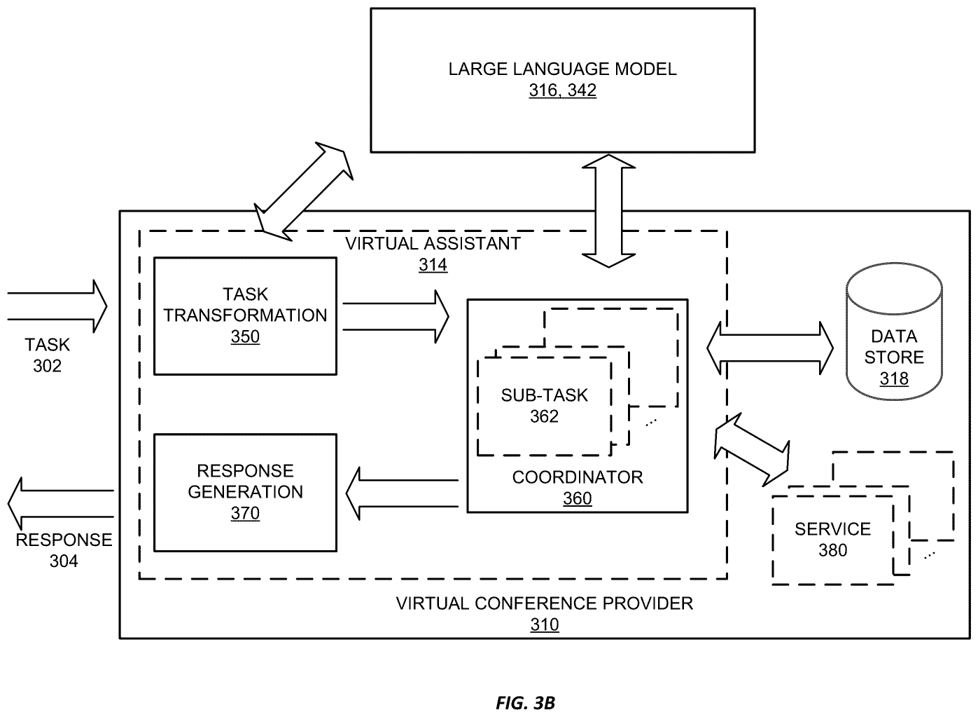

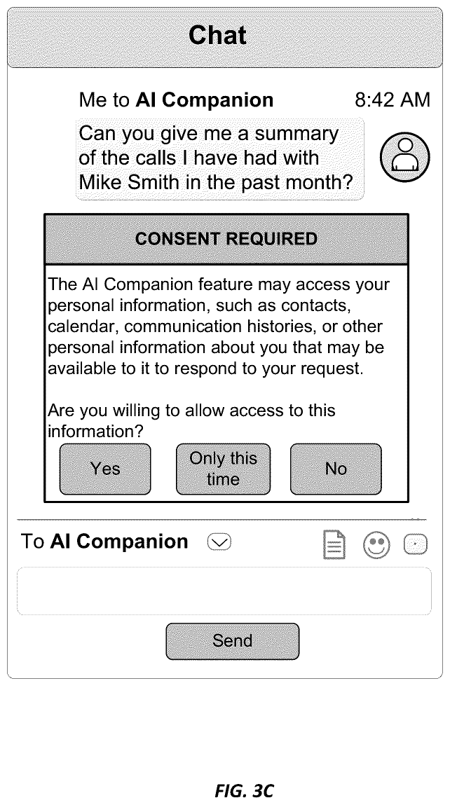

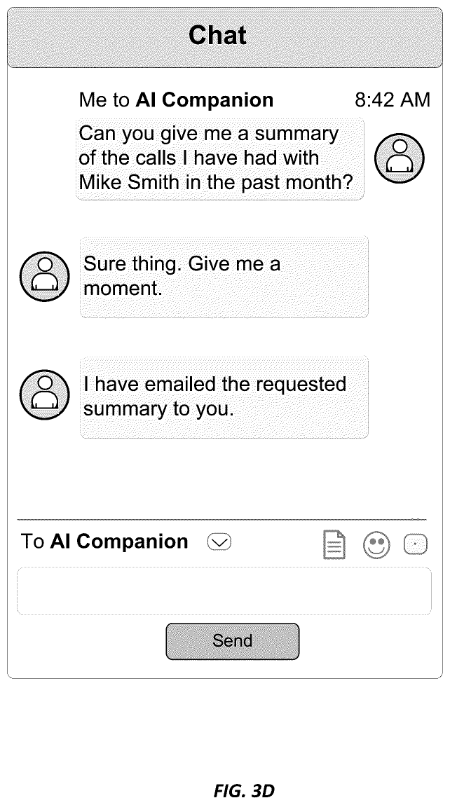

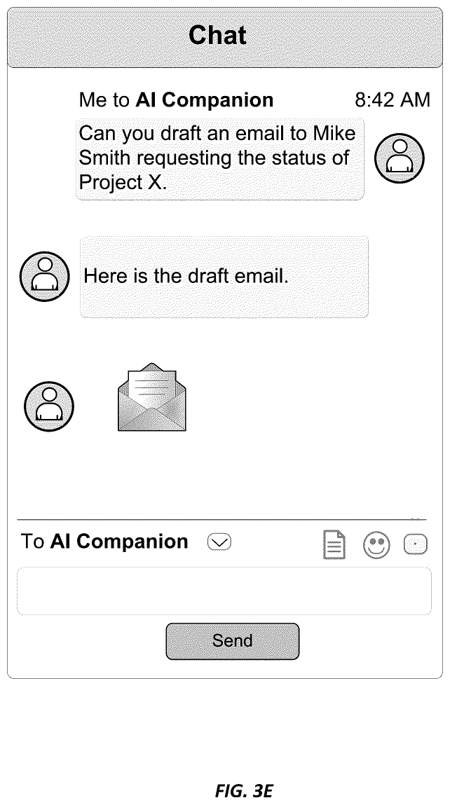

Referring now to FIGS. 3A-3B, FIG. 3A shows an example system 300 for LLM-enhanced virtual assistants. In this example, the system 300 includes a client device 330, a virtual conference provider 310, one or more remote servers 340 that host a LLM 342, and one or more remote servers 344 that host services that may invoked by an AI virtual assistant 314. In this example, the virtual conference provider 310 provides virtual conferencing capabilities, such as discussed above with respect to FIGS. 1-2, but also provides one or more servers 312 that provide AI virtual assistants 314 that may be allocated to requests received from users via their respective client device, such as client device 330, and one or more services 380 that may be invoked by the AI virtual assistants 314. In addition, the virtual conference provider 310 maintains its own LLM 310 that may be employed by a virtual assistant 314 instead of (or in addition to) the LLM 342 hosted by the remote server 340.

To obtain assistance from an AI virtual assistant 314, a user of the client device 330 may interact with the AI virtual assistant 314 via a web page or client application and request assistance by typing in or speaking a task for the AI virtual assistant 314 to perform. An example of such an interaction is shown in FIG. 3C.

As can be seen in FIG. 3C, a user has engaged in a chat session and has selected the AI Companion virtual assistant as the recipient of the task. The user has then entered a task for the virtual assistant to provide “a summary of the calls I have had with Mike Smith in the past month.” After entering the task, but before it has been provided to the AI virtual assistant 314, the GUI has displayed a consent authorization for the user to interact with. The consent authorization informs the user that their request may involve the AI virtual assistant 314 accessing multiple different types of information, which may be personal to the user. The user can then decide whether to grant permission to the AI virtual assistant 314 generally or only for this request. Alternatively, the user can decline to provide permission, which may prevent the AI virtual assistant from accessing the user's personal information.

Tasks may be questions or requests for information, instructions to perform one or more actions, or a combination of these. In examples that allow tasks to be spoken, the client device or the virtual conference provider may provide automatic speech recognition (“ASR”) 317 to convert the spoken task into text that can be received and processed by the AI virtual assistant. In some examples, the AI virtual assistant 314 may provide such ASR functionality, though other examples may employ ASR 317 to generate a textual representation of the task that is then passed to the AI virtual assistant 314.

The AI virtual assistant 314 receives a task from the client device 330 and interacts with an LLM 316, 342 to break the task down into sub-tasks that can be individually processed, identify the order of operation for the sub-tasks, and identify additional information that is needed from the client device 330. Each of the sub-tasks may invoke one or more services 380, either locally provided by the virtual conference provider 310 or by one or more remote servers, e.g., remote server(s) 344, to take actions or obtain information as a part of the AI virtual assistant handing the task. The sub-tasks are ordered and coordinated by coordinator functionality that receives ordering information from the LLM 316, 342. The coordinator can also aggregate the information received from the sub-tasks as they operate and provide the information to response generation functionality that can generate a final response to the client device once the task has been completed.

The services 380 may include any number of functionalities that may be provided by the virtual conference provider 310 or remote servers 344. For example, a task may be to setup a meeting with another person. Sub-tasks generated for the task may include identifying contact information for the person, determining free times on their calendar, generating a virtual conference meeting identifier and passcode, and generating a meeting agenda and invitation. Thus, the services 380 involved may include an employee directory or email directory service, a calendar service, a virtual conference service, and an LLM (e.g., LLM 316, 342) to generate a title and agenda for the meeting. Other suitable services may include document management systems, search engines, support ticket systems, telephone systems, chat systems, or music or video playback systems. However, any suitable service may be employed according to different examples.

By employing a LLM to help break down the task received from the client device, and by using the LLM to assist with executing the sub-tasks, the AI virtual assistant can 314 efficiently and accurately handle tasks on behalf of various users. In addition, the use of an LLM allows the user to provide a natural language description of a task to be performed and to interact with the AI virtual assistant in an intuitive manner to obtain the desired result.

Referring now to FIG. 3B, FIG. 3B illustrates a more detailed view of the virtual conference provider 310 depicted in FIG. 3A. The virtual conference provider 310 includes an AI virtual assistant 314 that includes task transformation 350 functionality, a coordinator that can coordinate the execution of one or more sub-tasks 362, and response generation functionality 370 that can generate a response to a user after completion of a task 302. As discussed above, the virtual conference provider 310 also provides one or more services 380 that may be invoked to perform one or more sub-tasks 362. In addition, the virtual conference provider 310 includes a data store 318 that includes information about the available services at the virtual conference provider 310.

When a task 302 is received from a remote client device, e.g., client device 330, the AI virtual assistant 350 employs its task transformation functionality to provide the task 302 to the LLM 316, 342 and request the LLM 316, 342 to break down the task into sub-tasks 362, to provide an ordering for the sub-tasks 362, and to identify additional information to be requested to perform the requested task 302. The task transformation functionality 350 may provide a series of text prompts to the LLM 316, 342 to invoke this functionality such as:
Prompt 1: I have a task that needs to be performed and I have some questions for you about the task. Here is the task: [Task description]
Prompt 2: Please provide the sub-tasks that need to be performed to accomplish this task
Prompt 3: Please identify the ordering of the sub-tasks, including whether any sub-task is not dependent on another sub-task to complete.
Prompt 4: Please identify information that is not included in the task that may be needed to complete one or more of the sub-tasks.

In response to the prompts, the LLM 316, 342 provides one or more sub-tasks 362 to be performed, as well as the ordering of those sub-tasks 362, and additional information to be requested from the user.

If additional information is requested, the task transformation functionality 350 may output a message to the user identifying the additional information that is needed. After receiving the information, the task transformation functionality may issue one or more additional prompts to the LLM 316, 342 that provides the additional information and requests any additional sub-tasks 362 or further information that may be needed. This continues until no additional information is required from the user. For example, if the user sends a task to “Summarize my conversations last week about project X to help me prepare for my 11 am meeting,” the AI virtual assistant 314 may issue the prompts identified above.

In addition, the AI virtual assistant 314 may also request additional information from the user. For example, to help the AI virtual assistant 314 identify relevant content to access and summarize, it may ask the user to identify which services the user has engaged with about Project X, such as email chats, meetings, or phone calls. The user may then respond, using natural language, to identify those services, or it may select one or more options from a GUI window. The AI virtual assistant may then construct an additional prompt to the LLM 316, 342 to identify those services. In some cases, the AI virtual assistant may instead identify the user's email inbox and chat channels the user is a member of, such as by accessing the user's profile, by default and not request additional information. Similarly, to obtain information about meetings, the AI assistant may await information from the LLM 316, 342 in response to one or more prompts, which may then identify a calendar service and instructions regarding how to interface with the calendar service, such as via an API or messaging interface.

After the sub-tasks 362 have been identified, they are provided to the coordinator along with the ordering of the sub-tasks 362. Some sub-tasks 362 may be dependent on the completion of other sub-tasks 362, and thus they must be executed in order. However, some sub-tasks 362 may not be dependent on other sub-tasks 362 and may be executed at any time, or in parallel with other sub-tasks 362. Further, in some cases the LLM indicate that additional information is needed from the user, which the AI virtual assistant 314 may then communicate to the user, such as via the chat functionality shown in FIG. 3C. After obtaining the additional information, the AI virtual assistant 314 may provide the additional information to the LLM 314, 342, which may then identify one or more additional sub-tasks.

For example, to assist the user with the summarization task requested above, the sub-tasks may include obtaining chat logs from one or more chat channels, obtaining emails from the user's email system, obtaining meeting information from the user's calendar, obtaining transcripts for relevant meetings, and so forth.

To execute a sub-task, the coordinator 360 accesses the data store 318 and obtains information about the available services 380. In this example, the data store 318 includes a directory of the available services 380 that includes a textual description of the capabilities of each service 380 as well as instructions regarding how to invoke those capabilities. For services hosted by remote servers 344, the coordinator 360 may request such information from the remote servers 344. The instructions regarding how to invoke service functionality may include a description of an API, one or more functions provided by the API and a description of what each function does and what information it needs and what information it outputs, or a format for a messaging interface or sequence of messages for one or more such functionalities. And while this example involves an API or messaging interface, other interfaces may be used as well, such as inter-process communication or a query interface for a database management system, such as structured query language (“SQL”).

In some cases, the LLM 316, 342 may also specify an order for one or more sub-tasks or it may identify dependencies between sub-tasks. For example, if five sub-tasks are identified, the LLM 316, 342 may specify the order the sub-tasks should be executed in and whether the output of one or more sub-tasks should be used as an input to another sub-task. For example, the LLM 316, 342 may identify five sub-tasks and specify the order as being sub-tasks one and two to be performed first, followed by sub-task three, followed by sub-task four that takes the output of sub-tasks one and three as input, and finally sub-task five that takes the output of sub-tasks two and four as input. The coordinator 360 may obtain the sequencing information in addition to the identified sub-tasks and use the sequencing information to execute the sub-tasks in the proper sequence and with the appropriate inputs.

After obtaining the information about the available services 380, the coordinator 360 prompts the LLM 316, 342 by identifying a particular sub-task 362 and the descriptions of the available services 380 to determine which service(s) should be invoked to handle the sub-task 362. Based on the sub-task and the descriptions of the available services 380, the LLM 316, 342 identifies one or more services that closely match the sub-task and provides an identification of the service(s) to the coordinator 360. The LLM 316, 342 may also identify an interface, e.g., an application programming interface (“API”) or formatting for messages to be sent to the service, to perform the sub-task. In some examples, the LLM 316, 342 The coordinator 360 can then use the response from the LLM 316, 342 to invoke the appropriate service(s) 380, such as by calling the corresponding API or generating and sending one or more messages to the task, whether hosted by the virtual conference provider 310 or a remote server 344, to obtain information or perform an action. The coordinator 360 can then process each of the sub-tasks 362 in a similar way according to the order defined by the LLM 316, 342. Further, in some examples, the LLM 316, 342 itself may perform the operation specified by the sub-task 362, such as by directly interacting with an appropriate service or services according to the description of the services and instructions regarding how to invoke functionality of those services stored in the data store 318. For example, the LLM 316, 342 may generate and output a message or database command to a service 380 to obtain information from the service 380.

As the sub-tasks 362 execute and complete, the coordinator 360 accumulates information about each completed sub-task 362, such as information obtained or actions performed. For example, for the user's request for a summary of his conversations about Project X, the various sub-tasks may provide one or more emails, chat logs, or meeting or phone call transcripts to the coordinator. The information may be provided to subsequent sub-tasks 362 to use, such as a summarization sub-task, or may be accumulated to use to generate a response to the user who initially submitted the task 302. If certain sub-tasks depend on the completion of prior sub-tasks, the coordinator 360 can determine whether a further sub-task is ready to be performed based on a completion status of one or more other sub-tasks. For example, in this example, a summary of the conversations needs the underlying conversations to be obtained first. Once any necessary prior sub-tasks have been completed, the coordinator 360 can then execute the further sub-task. Thus, after the coordinator has executed sub-tasks to obtain the various conversation information, such as by invoking services 380 associated with one or more chat channels, an email inbox, and a transcript repository, the coordinator can then invoke the next sub-task and provide the various conversation information as inputs. Thus, the coordinator 360 can employ the sequencing information

Once all of the sub-tasks 362 have completed, the AI virtual assistant 314 invokes its response generation functionality 370 to generate a response to send to the user who submitted the task. In this example, the response generation functionality 370 provides one or more prompts to the LLM 370 to generate a suitable response to the user. For example, in the case of providing the summary, the LLM 316, 342 itself may generate the summary. The summary may then represent the final output to provide to the user. However, if the original task was to generate an email to another person, the response generation functionality 370 may provide a draft email body provided from a sub-task along with the email address of the targeted person from a different sub-task. It may then obtain a subject for the email from a third sub-task, which may have generated the subject based on the draft email body. The response generation functionality 370 may then provide one or more prompts to the LLM 316, 342 to generate an email along with the outputs from the sub-tasks and an indication of what each output represents, e.g., the email body, the email address, and the subject line. The LLM 316, 342 may then generate an email document according to a particular format, which may then be provided to the user as an email file along with a message indicating that the email has been created. Other examples may simply indicate that a requested action has been performed.

After the response 304 has been generated, it is transmitted to the remote client device 330 where it is displayed to the user. For example, the summary may be output to the GUI or it may be delivered in another format, if specified by the user, e.g., as an email, as shown in FIG. 3D. In some cases, a message may be output in the GUI indicating that the output has been generated, such as an email requested by the user. The email may be also included in the message or as a separate message within the GUI, such as is shown in FIG. 3E.

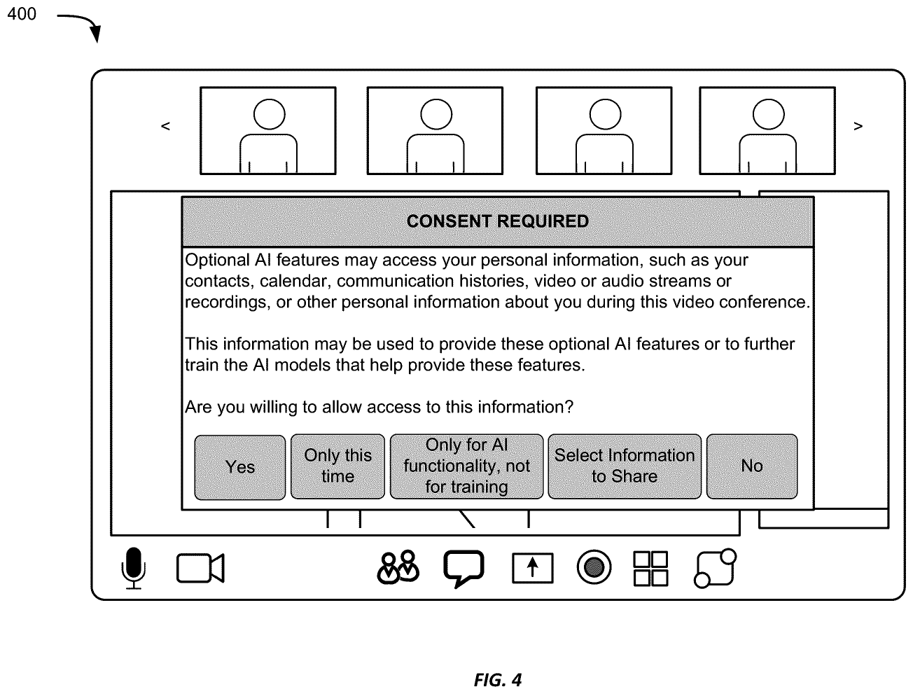

Referring to FIG. 4, FIG. 4 shows a GUI 400 presenting a consent option to employ certain AI-assisted features. In some examples according to the present disclosure, a user may select an option to use one or more optional AI features available from the virtual conference provider, such as the LLM-enhanced virtual assistants as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 4, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

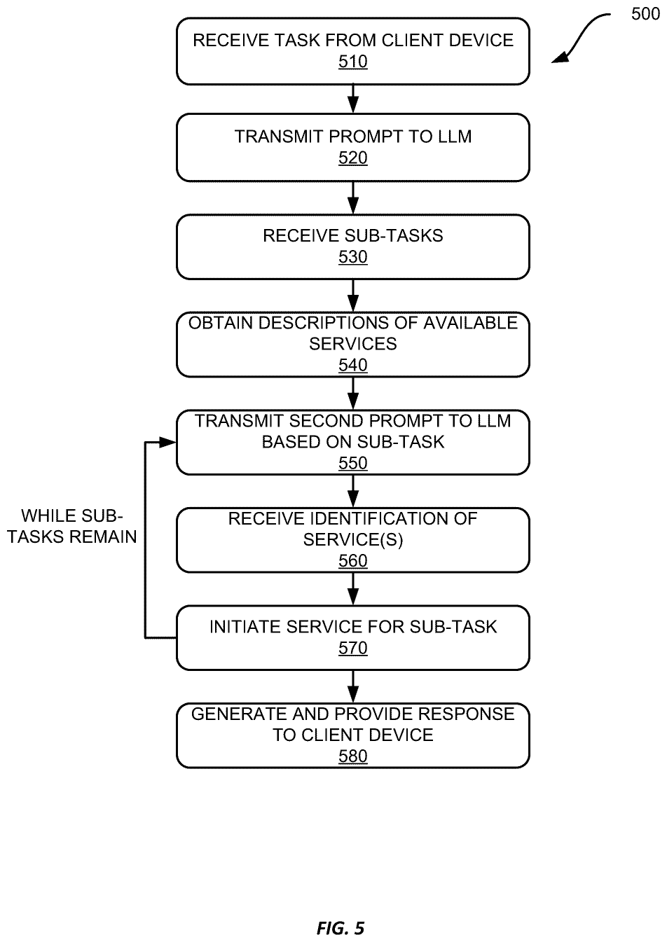

Referring now to FIG. 5, FIG. 5 shows an example method 500 for LLM-enhanced AI virtual assistants. The method 500 will be described with respect to the example system 300 shown in FIG. 3A and the example virtual conference provider 310 shown in FIG. 3B. However, it should be appreciated that any suitable system according to this disclosure may be employed.

At block 510, the AI virtual assistant 314 receives a task 302 from a remote client device 330. In this example, the AI virtual assistant 314 is executed by a server at the virtual conference provider 310; however, the AI virtual assistant 314 may be executed by any suitable computing device. Thus, an AI virtual assistant 314 need not be provided by a virtual conference provider 310, but may provided by any entity or may be executed locally on a user's own client device 330.

At block 520, the AI virtual assistant 314 transmits a first prompt to a LLM 316, 342 that includes the task 302 a request to process the task 302. As discussed above with respect to FIG. 3B, the AI virtual assistant 314 employs task transformation functionality 350 to provide one or more prompts to the LLM 316, 342 to process the task, such as to generate one or more sub-tasks 362, provide an ordering for the sub-tasks 362, or request additional information from the requesting user.

At block 530, the AI virtual assistant 314 receives a response from the LLM 316, 342 that includes one or more sub-tasks 362 and an ordering of the sub-tasks 362, if multiple sub-tasks 362 are provided. As discussed above with respect to FIG. 3B, the LLM 316, 342 generates descriptions of the sub-tasks 362 and provides an order for the sub-tasks 362 in cases where one or more sub-tasks 362 depend on another sub-task 362 or sub-tasks 362.

At block 540, the coordinator 360 obtains descriptions of a plurality of available services 380. As discussed above with respect to FIG. 3B, a directory of the available services 380 may be stored in a data store 318 and may be accessed to obtain descriptions of the available services 380. If services 380 are available from multiple different entities, those entities may be queried to obtain descriptions of the available services 380. The coordinator 360 may also obtain information regarding how to invoke functionality offered by the various services, including information about corresponding APIs, messaging interfaces, database query languages, or inter-process communication information.

At block 550, the coordinator 360 transmits one or more prompts to the LLM 316, 342 for a sub-task 362 that includes a description of the sub-task 362 and the available services 380, and requests instructions on which service or services 380 to employ to complete the sub-task 362 as discussed above with respect to FIG. 3B. The coordinator 360 may perform this functionality for each identified sub-task.

At block 560, the coordinator 360 receives an identification of one or more available services 380 from the LLM 316, 342. As discussed above with respect to FIG. 3B, the LLM 316, 342 identifies the applicable services 380 based on the sub-task and the descriptions of the available services 380 and provides it to the coordinator 360. In some examples, the LLM 316, 342 may also provide, or be prompted to provide, a format for a message, API call(s), database query, or a formatted message itself to be sent to the identified service(s).

At block 570, the coordinator 360 initiates the one or more identified services as discussed above with respect to FIG. 3B based on the information received from the LLM 316, 342. It should be appreciated that blocks 550-570 are performed for each sub-task 362. While FIG. 5 depicts a loop, multiple sub-tasks may be executed in parallel, while others may be executed in series, depending on the ordering received from the LLM 316, 342 at block 530.

At block 580, after the sub-tasks 362 have been executed, the AI virtual assistant 314 invokes the response generation functionality 370 to generate a response 304 to the user who submitted the task. As discussed above, the response may take any suitable form, depending on the requested task. For example, if the request was for information, the response may include an LLM-generated natural language response including the requested information. If the request was to schedule a meeting or draft an email, the response may include a draft meeting invitation or a draft email. If the request was to submit a tech support ticket, the response may be a confirmation that the ticket was submitted and a confirmation number or ticket number. Still other suitable responses may be generated according to the particular task 302 that was submitted by the user.

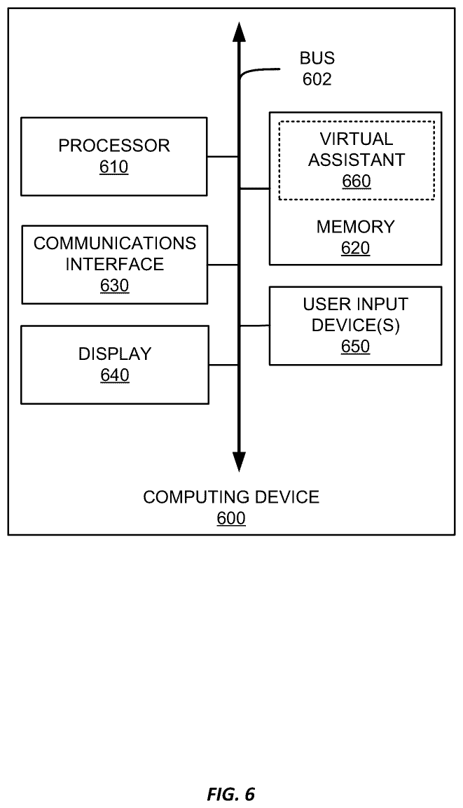

Referring now to FIG. 6, FIG. 6 shows an example computing device 600 suitable for use in example systems or methods for LLM-enhanced virtual assistants according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for LLM-enhanced virtual assistants according to different examples, such as part or all of the example method 500 described above with respect to FIG. 5. Suitable example computing devices 600, such as user client devices, may also include one or more user input devices 650, such as a keyboard, mouse, touchscreen, microphone, etc., to accept user input. The computing device 600 also includes a display 640 to provide visual output to a user. In addition, the computing device 600 includes an AI virtual assistant 660 to allow the computing device to receive and handle tasks received from a user.

The computing device 600 also includes a communications interface 640. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by a virtual assistant executed by a server, a task from a remote client device;
transmitting a first prompt to a large language model (“LLM”), the first prompt comprising the task and a request to process the task;
receiving, from the LLM in response to the first prompt, a plurality of sub-tasks and an ordering of the plurality of sub-tasks;
obtaining descriptions of a plurality of available services;
for each sub-task:
transmitting a second prompt to the LLM, the second prompt comprising a description of the respective sub-task and the descriptions of the available services;
receiving, from the LLM in response to the respective second prompt, an identification of one or more available services; and
initiating, for the respective sub-task, the one or more identified available services; and
after completion of the plurality of sub-tasks, generating and providing a response to the task to the remote client device.

2. The method of claim 1, further comprising receiving from the LLM, in response to the first prompt, an indication of a need to request additional information from the remote client device.

3. The method of claim 2, further comprising:
transmitting a request for additional information to the remote client device, the request based on the indication of the need to request additional information from the remote client device;
receiving supplemental information from the remote client device in response to the request; and
transmitting a supplemental first prompt to the LLM based on the supplemental information.

4. The method of claim 1, wherein the task comprises a natural-language description of an action to perform.

5. The method of claim 1, wherein each sub-task comprises a natural-language description of an action to perform.

6. The method of claim 1, wherein the available services comprise a database management system, a calendar, a LLM, a video conferencing system, a telephone system, or a search engine.

7. The method of claim 1, further comprising:
providing the plurality of sub-tasks and the ordering to a coordinator process; and
wherein the coordinator process is configured to perform the plurality of sub-tasks according to the ordering.

8. A system comprising:
a communications interface;
a non-transitory computer-readable medium; and
one or more processors configured to execute processor-executable instructions stored in the non-transitory computer-readable medium to:
receive a task from a remote client device;
transmit a first prompt to a large language model (“LLM”), the first prompt comprising the task and a request to process the task;
receive, from the LLM in response to the first prompt, a plurality of sub-tasks and an ordering of the plurality of sub-tasks;
obtain descriptions of a plurality of available services;
for each sub-task:
transmit a second prompt to the LLM, the second prompt comprising a description of the respective sub-task and the descriptions of the available services;
receive, from the LLM in response to the respective second prompt, an identification of one or more available services; and
initiate, for the respective sub-task, the one or more identified available services; and
after completion of the plurality of sub-tasks, generate and provide a response to the task to the remote client device.

9. The system of claim 8, wherein the one or more processors are configured to execute further processor-executable instructions stored in the non-transitory computer-readable medium to receive from the LLM, in response to the first prompt, an indication of a need to request additional information from the remote client device.

10. The system of claim 9, wherein the one or more processors are configured to execute further processor-executable instructions stored in the non-transitory computer-readable medium to:
transmit a request for additional information to the remote client device, the request based on the indication of the need to request additional information from the remote client device;
receive supplemental information from the remote client device in response to the request; and
transmit a supplemental first prompt to the LLM based on the supplemental information.

11. The system of claim 8, wherein the task comprises a natural-language description of an action to perform.

12. The system of claim 8, wherein each sub-task comprises a natural-language description of an action to perform.

13. The system of claim 8, wherein the available services comprise a database management system, a calendar, a LLM, a video conferencing system, a telephone system, or a search engine.

14. The system of claim 8, wherein the one or more processors are configured to execute further processor-executable instructions stored in the non-transitory computer-readable medium to:
provide the plurality of sub-tasks and the ordering to a coordinator process; and
wherein the coordinator process is configured to perform the plurality of sub-tasks according to the ordering.

15. A non-transitory computer-readable medium comprising processor-executable instructions configured to cause one or more processors to:
receive a task from a remote client device;
transmit a first prompt to a large language model (“LLM”), the first prompt comprising the task and a request to process the task;
receive, from the LLM in response to the first prompt, a plurality of sub-tasks and an ordering of the plurality of sub-tasks;
obtain descriptions of a plurality of available services;
for each sub-task:
transmit a second prompt to the LLM, the second prompt comprising a description of the respective sub-task and the descriptions of the available services;
receive, from the LLM in response to the respective second prompt, an identification of one or more available services; and
initiate, for the respective sub-task, the one or more identified available services; and
after completion of the plurality of sub-tasks, generate and provide a response to the task to the remote client device.

16. The non-transitory computer-readable medium of claim 15, further comprising processor-executable instructions configured to cause one or more processors to receive from the LLM, in response to the first prompt, an indication of a need to request additional information from the remote client device.

17. The non-transitory computer-readable medium of claim 16, further comprising processor-executable instructions configured to cause one or more processors to:
transmit a request for additional information to the remote client device, the request based on the indication of the need to request additional information from the remote client device;
receive supplemental information from the remote client device in response to the request; and
transmit a supplemental first prompt to the LLM based on the supplemental information.

18. The non-transitory computer-readable medium of claim 15, wherein the task comprises a natural-language description of an action to perform.

19. The non-transitory computer-readable medium of claim 15, wherein each sub-task comprises a natural-language description of an action to perform.

20. The non-transitory computer-readable medium of claim 15, wherein the available services comprise a database management system, a calendar, a LLM, a video conferencing system, a telephone system, or a search engine.

21. The non-transitory computer-readable medium of claim 15, further comprising processor-executable instructions configured to cause one or more processors to:
provide the plurality of sub-tasks and the ordering to a coordinator process; and
wherein the coordinator process is configured to perform the plurality of sub-tasks according to the ordering.
